(19) United States
(12) Patent Application Publication
(10) Pub. No.: US 2024/0233002 A1
(43) Pub. Date: Jul. 11, 2024

(54) MOVING OBJECT MANAGEMENT SYSTEM AND MOVING OBJECT MANAGEMENT METHOD

(71) Applicant: SONY GROUP CORPORATION, TOKYO (JP)

(72) Inventors: KAZUMASA MIYAZAKI, TOKYO (JP); MASASHI MORI, TOKYO (JP)

(21) Appl. No.: 18/560,131

(22) PCT Filed: Feb. 1, 2022
(86) PCT No.: PCT/JP2022/003744

§ 371 Date: Nov. 10, 2023

(30) Foreign Application Priority Data
May 27, 2021 (JP) 2021-089401

(51) Int. Cl. G06Q 30/0645; G07C 9/00; H04W 4/02; H04W 4/029

(52) U.S. Cl. CPC G06Q 30/0645; G07C 9/00309; H04W 4/023; H04W 4/029; G07C 2209/63

(57) ABSTRACT

A moving object management system (1) includes: a detection unit (14b) that traces relative positions of a bicycle (B) (corresponding to an example of a “moving object”) and a user terminal (50) carried by a user (U) who temporarily uses the bicycle (B), and that detects a distance based on the traced relative positions; a lock control unit (14c) that performs automatic locking with respect to the bicycle (B) depending on the distance detected by the detection unit (14b); and a fee calculation unit (103d) that dynamically changes a usage fee for using the bicycle (B) according to a state in which the automatic locking is used.

### FIELD

The present disclosure relates to a moving object management system and a moving object management method.

### BACKGROUND

Conventionally, a temporary use service that allows a user to temporarily use a moving object such as a bicycle, including a rental cycle or a share cycle, has been known. In addition, in such a temporary use service, a technology for automating a series of necessary functions such as user authentication, locking and unlocking of a moving object, and prevention of theft by using a mobile terminal with a global positioning system (GPS) function owned by a user has also been proposed (for example, see Patent Literature 1).

### CITATION LIST

### Patent Literature

Patent Literature 1: JP 2015-060452 A

### SUMMARY

### Technical Problem

However, the above-described conventional technology has room for further improvement in accurately grasping a status of the moving object and appropriately reflecting a difference in risk during temporary use in a usage fee.

For example, it is possible to grasp a position of the moving object and a change in position of the moving object by using the GPS as in the conventional technology, but it is not possible to identify whether the position is changed by the hand of the user or the position is changed in a state where the moving object is away from the user.

At this point, there is a method of grasping relative positions using the GPS of the mobile terminal owned by the user and the GPS of the moving object. However, this method has problems that the GPSs cannot be used in a place where the sky cannot be seen, and a position error occurs due to multipath or the like caused by reflection from a mountain or a building even in a place where the sky can be seen.

In addition, in a case where the moving object can be automatically locked, for example, while the moving object is temporarily parked, it is possible to prevent a theft that may occur when it is forgotten to lock the moving object, and thus, it is possible to reduce a risk of theft. On the other hand, in a case where the user manually locks the moving object, a risk of theft is higher than that in a case where the moving object can be automatically locked. It is preferable that such a difference is appropriately reflected in the usage fee for using the moving object.

Therefore, the present disclosure proposes a moving object management system and a moving object management method capable of accurately grasping a situation of a moving object and appropriately reflecting in the usage fee a difference in risk while the moving object is temporarily used.

### Solution to Problem

In order to solve the above problems, one aspect of a moving object management system according to the present disclosure includes: a detection unit that traces relative positions of a moving object and a user terminal carried by a user who temporarily uses the moving object, and that detects a distance based on the traced relative positions; a lock control unit that performs automatic locking with respect to the moving object depending on the distance detected by the detection unit; and a fee calculation unit that dynamically changes a usage fee for using the moving object according to a state in which the automatic locking is used.

### BRIEF DESCRIPTION OF DRAWINGS

FIG. 1 is a diagram schematically illustrating a moving object management method according to an embodiment of the present disclosure.

FIG. 2 is a diagram illustrating an example of a configuration of a moving object management system according to the embodiment of the present disclosure.

FIG. 3 is a block diagram illustrating an example of a configuration of an in-vehicle device according to the embodiment of the present disclosure.

FIG. 4 is a block diagram illustrating an example of a configuration of a return port according to the embodiment of the present disclosure.

FIG. 5 is a block diagram illustrating an example of a configuration of a user terminal according to the embodiment of the present disclosure.

FIG. 6 is a block diagram illustrating an example of a configuration of a server device according to the embodiment of the present disclosure.

FIG. 7 is a diagram (state transition 1) illustrating a state transition in the moving object management system according to the embodiment of the present disclosure.

FIG. 8 is a diagram (state transition 2) illustrating a state transition in the moving object management system according to the embodiment of the present disclosure.

FIG. 9 is a diagram (UI screen 1) illustrating a specific example of a UI screen presented on the user terminal.

FIG. 10 is a diagram (UI screen 2) illustrating a specific example of a UI screen presented on the user terminal.

FIG. 11 is a diagram (UI screen 3) illustrating a specific example of a UI screen presented on the user terminal.

FIG. 12 is a diagram (UI screen 4) illustrating a specific example of a UI screen presented on the user terminal.

FIG. 13 is a diagram (UI screen 5) illustrating a specific example of a UI screen presented on the user terminal.

FIG. 14 is a diagram (UI screen 6) illustrating a specific example of a UI screen presented on the user terminal.

FIG. 15 is a diagram (UI screen 7) illustrating a specific example of a UI screen presented on the user terminal.

FIG. 16 is a diagram (UI screen 8) illustrating a specific example of a UI screen presented on the user terminal.

FIG. 17 is a diagram (UI screen 9) illustrating a specific example of a UI screen presented on the user terminal.

FIG. 18 is a diagram (UI screen 10) illustrating a specific example of a UI screen presented on the user terminal.

FIG. 19 is a diagram (UI screen 11) illustrating a specific example of a UI screen presented on the user terminal.

FIG. 20 is a diagram (UI screen 12) illustrating a specific example of a UI screen presented on the user terminal.

FIG. 21 is a flowchart (flowchart 1) illustrating a processing procedure executed by the moving object management system.

FIG. 22 is a flowchart (flowchart 2) illustrating a processing procedure executed by the moving object management system.

FIG. 23 is a flowchart (flowchart 3) illustrating a processing procedure executed by the moving object management system.

FIG. 24 is a diagram (usage fee 1) for explaining a usage fee.

FIG. 25 is a diagram (usage fee 2) for explaining a usage fee.

FIG. 26 is a hardware configuration diagram illustrating an example of a computer realizing the functions of the in-vehicle device.

### DESCRIPTION OF EMBODIMENTS

Hereinafter, embodiments of the present disclosure will be described in detail with reference to the drawings. Note that, in the following embodiments, the same parts will be denoted by the same reference signs, and redundant description will be omitted.

In the following description, a case where a moving object temporarily used by a user U is a bicycle B will be described as an example, but the type of moving object is not limited as long as a temporary use service is applied to the moving object.

In addition, the present disclosure will be described according to the following order of items.
1. Outline of Embodiment of Present Disclosure
2. Configuration of Moving Object Management System
2-1. Overall Configuration
2-2. Configuration of In-Vehicle Device
2-3. Configuration of Return Port
2-4. Configuration of User Terminal
2-5. Configuration of Server Device
3. Description of State Transition
3-1. Start of Reservation
3-2. Detection of Bicycle
3-3. Start of Use (Travel)
3-4. Temporary Parking
3-5. Restart of Use
3-6. Termination of Use
3-7. Report of Theft
3-8. Switch to Manual Locking Mode
3-9. Usage Fee
3-10. Others
4. Other Modifications
5. Hardware Configuration
6. Conclusion

### 1. Outline of Embodiment of Present Disclosure

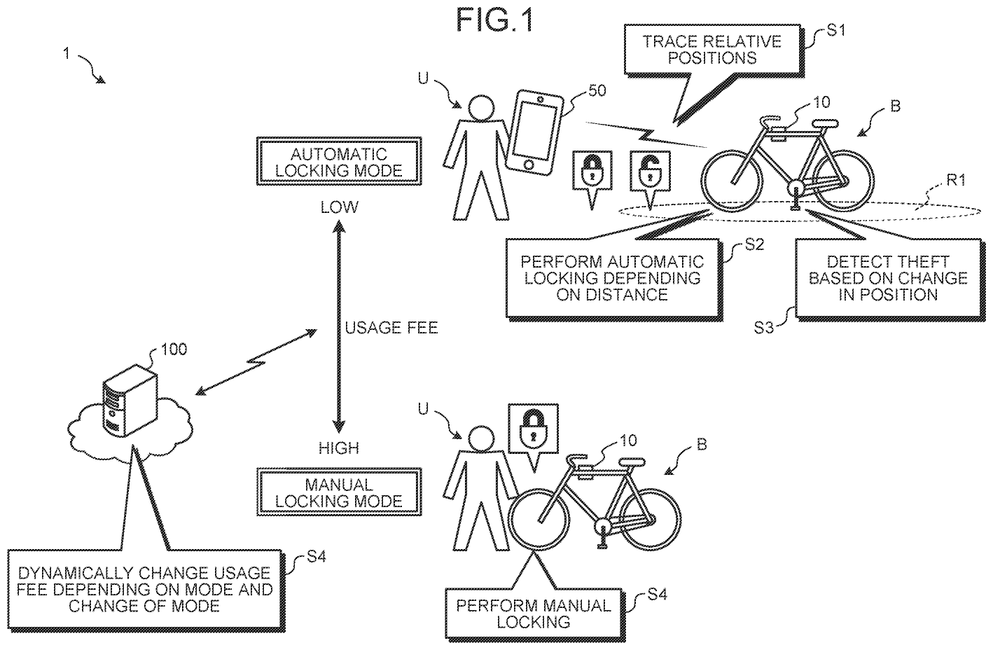

First, an outline of a moving object management method according to an embodiment (hereinafter, appropriately referred to as “the present embodiment” or simply “the embodiment”) of the present disclosure will be described. FIG. 1 is a diagram schematically illustrating a moving object management method according to the embodiment of the present disclosure.

As illustrated in FIG. 1, a moving object management system 1 according to the embodiment includes an in-vehicle device 10, a user terminal 50, and a server device 100.

The in-vehicle device 10 is a computer mounted on the bicycle B. The user terminal 50 is a terminal device used by the user U who temporarily uses the bicycle B. The server device 100 is a device managed and operated by a business operator providing a service for temporarily using the bicycle B.

Incidentally, the existing technology using such a moving object management system 1 has room for further improvement in accurately grasping a status of the bicycle B and appropriately reflecting a difference in risk during the temporary use in the usage fee.

For example, it is possible to grasp a position of the bicycle B and a change in position of the bicycle B by using the GPS as in the existing technology, but it is not possible to identify whether the position is changed by the hand of the user U or the position is changed in a state where the bicycle B is away from the user U.

At this point, there is a method of grasping relative positions using the GPS of the user terminal 50 owned by the user U and the GPS of the bicycle B. However, this method has problems that the GPSs cannot be used in a place where the sky cannot be seen, and a position error occurs due to multipath or the like caused by reflection from a mountain or a building even in a place where the sky can be seen.

In addition, in a case where the bicycle B can be automatically locked, for example, while the bicycle B is temporarily parked, it is possible to prevent a theft that may occur when it is forgotten to lock the bicycle B, and thus, it is possible to reduce a risk of theft. On the other hand, in a case where the user U manually locks the bicycle B, a risk of theft is higher than that in a case where the bicycle B can be automatically locked. It is preferable that such a difference is appropriately reflected in the usage fee for using the bicycle B.

Therefore, the moving object management method according to the embodiment includes tracing relative positions of the bicycle B and the user terminal 50 carried by the user U who temporarily uses the bicycle B to detect a distance based on the traced relative positions, performing automatic locking with respect to the bicycle B depending on the detected distance, and dynamically changing a usage fee for using the bicycle B according to a state in which the automatic locking is used.

As illustrated in FIG. 1, first, the moving object management system 1 manages the bicycle B in two modes, i.e., an “automatic locking mode” and a “manual locking mode”. The “automatic locking mode” is a mode in which the bicycle B can be automatically locked depending on a distance between the in-vehicle device 10 and the user terminal 50.

As illustrated in FIG. 1, in the automatic locking mode, the moving object management system 1 traces relative positions of the in-vehicle device 10 and the user terminal 50 (Step S1). Then, automatic locking is performed depending on a distance between the in-vehicle device 10 and the user terminal 50 based on the traced relative positions (Step S2). In addition, a theft is detected based on a change in position during automatic locking (Step S3).

Specifically, in the moving object management method according to the embodiment, in Step S1, a communication path for directly connecting the in-vehicle device 10 and the user terminal 50 to each other is established using near-field wireless communication such as Bluetooth (registered trademark). Then, while observing an intensity of a radio wave and an error rate in the near-field wireless communication, relative positions of the in-vehicle device 10 and the user terminal 50 are continuously traced, and relative position information is shared by the in-vehicle device 10 and the user terminal 50.

Note that the intensity of the radio wave attenuates in proportion to the square of the distance in the ideal space, and the error rate is affected by an increase in distance, presence of an obstacle, reflection, or the like.

Then, in the moving object management method according to the embodiment, in Step S2, when it is determined based on the traced relative positions that the user U is outside a predetermined proximity region R1, the bicycle B is regarded as temporarily parked, and automatic unlocking is performed with respect to the bicycle B. When the user U returns from the outside to the inside of the proximity region R1, automatic unlocking is performed.

In addition, in the moving object management method according to the embodiment, in Step S3, a theft of the moving object is detected depending on whether the moving object moves together with the user U using a change in position of the in-vehicle device 10 through the GPS and the above-described relative position information.

In this way, by executing Steps S1 to S3 using the near-field wireless communication, it is possible to accurately grasp a status of the bicycle B.

On the other hand, as illustrated in FIG. 1, in the manual mode, the moving object management system 1 requires the user U to manually lock the bicycle B (Step S4).

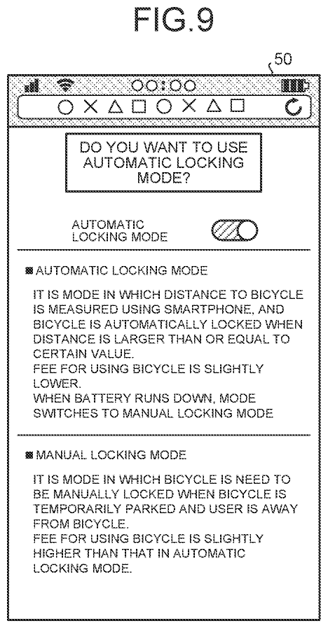

Whether the user U uses the automatic locking mode can be selected by the user U on a user interface (UI) screen of the user terminal 50 at the time of making a use contract. Various specific examples of the UI screen will be described later with reference to FIGS. 9 to 20.

In a case where the automatic locking mode is used, it is possible to prevent a theft that may occur when it is forgotten to lock the bicycle B, and thus, it is possible to reduce a risk of theft. On the other hand, in a case where the manual locking mode is used, a risk of theft is higher than that in the case where the automatic locking mode is used, given that it may be forgotten to lock the bicycle B.

Then, it is required that a difference in risk of theft be appropriately reflected in a usage fee for using the bicycle B. In the moving object management method according to the embodiment, the usage fee in the automatic locking mode is set to be lower than that in the manual locking mode, because the service provider providing the temporary use service is basically a management entity in the automatic locking mode.

However, the in-vehicle device 10 or the user terminal 50 may become unusable as the battery runs down. In such a case, even though the user U is using the automatic locking mode, the automatic locking mode cannot be continued, and thus, the automatic locking mode is switched to the manual locking mode. That is, the mode may change during the temporary use.

Therefore, in the moving object management method according to the embodiment, the server device 100 dynamically changes the usage fee added to the basic usage fee system depending on a mode and a change of the mode (Step S4). As a result, it is possible to appropriately reflect a difference in risk during the temporary use in the usage fee.

In this manner, the moving object management method according to the embodiment includes tracing relative positions of the bicycle B and the user terminal 50 carried by the user U who temporarily uses the bicycle B to detect a distance based on the traced relative positions, performing automatic locking with respect to the bicycle B depending on the detected distance, and dynamically changing a usage fee for using the bicycle B according to a state in which the automatic locking is used.

Therefore, the moving object management method according to the embodiment is capable of accurately grasping a status of the bicycle B and appropriately reflecting a difference in risk in the usage fee while the bicycle B is temporarily used.

Hereinafter, an example of a configuration of the moving object management system 1 to which the moving object management method according to the above-described embodiment is applied will be described in more detail.

### 2. Configuration of Moving Object Management System

### <2-1. Overall Configuration>

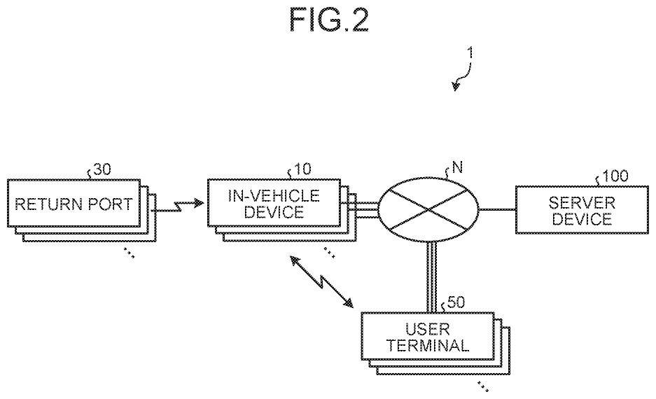

FIG. 2 is a diagram illustrating an example of a configuration of the moving object management system 1 according to the embodiment of the present disclosure. As illustrated in FIG. 2, the moving object management system 1 includes one or more in-vehicle devices 10, one or more return ports 30, one or more user terminals 50, and a server device 100.

In addition, as illustrated in FIG. 2, the in-vehicle device 10, the user terminal 50, and the server device 100 are connected to each other by a network N such as the Internet or a mobile telephone network, and are provided to be able to transmit and receive data to and from each other via the network N.

Furthermore, the in-vehicle device 10 and the user terminal 50 are provided to be able to directly transmit and receive data to and from each other by near-field wireless communication. Further, the in-vehicle device 10 is provided to be able to receive radio waves transmitted from the return port 30.

As described above, the in-vehicle device 10 is a computer mounted on the bicycle B. The return port 30 is a device corresponding to a place at which the bicycle B is returned, and is provided to be able to transmit radio waves toward the periphery.

The user terminal 50 is a mobile terminal device used by each user U, and executes various types of information processing according to what the user U operates various UIs such as a graphical user interface (GUI) and a voice UI for.

The user terminal 50 is a tablet terminal, a mobile phone such as a smartphone, a personal digital assistant (PDA), or the like. Furthermore, the user terminal 50 may be, for example, a wearable device or the like provided to be wearable by the user U.

The server device 100 is realized by, for example, a cloud server, and is a server device that provides a service for temporarily using the bicycle B including a series of necessary functions such as user authentication, use contract, locking of the bicycle B, unlocking of the bicycle B, and prevention of theft to the user U via the network N.

### <2-2. Configuration of In-Vehicle Device>

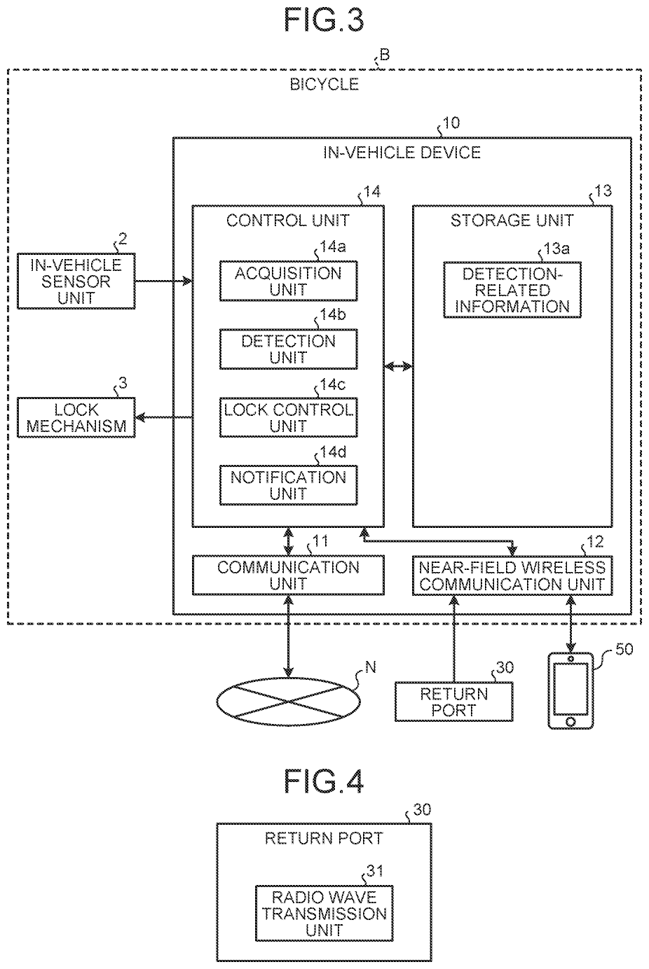

Next, FIG. 3 is a block diagram illustrating an example of a configuration of the in-vehicle device 10 according to the embodiment of the present disclosure. In FIG. 3 and FIGS. 4 to 6, which follow FIG. 3, only components necessary for describing the features of the present embodiment are shown, and general components are omitted.

In other words, each component illustrated in FIGS. 3 to 6 is functionally conceptual, and is not necessarily required to be physically configured as illustrated. For example, a specific form in which the blocks are distributed or integrated is not limited to what is illustrated, and all or some of the blocks can be functionally or physically distributed or integrated in certain units according to various loads, usage statuses, and the like.

In the description using FIGS. 3 to 6, already described components may be described in a simple manner or may not be described.

As illustrated in FIG. 3, the in-vehicle device 10 is mounted on the bicycle B. The bicycle B further includes an in-vehicle sensor unit 2 and a lock mechanism 3.

The in-vehicle sensor unit 2 is a group of various sensors mounted on the bicycle B. The in-vehicle sensor unit 2 includes, for example, a GPS sensor. The lock mechanism 3 is a mechanism that locks or unlocks the bicycle B under the control of a lock control unit 14c to be described later or manually.

The in-vehicle device 10 includes a communication unit 11, a near-field wireless communication unit 12, a storage unit 13, and a control unit 14. The communication unit 11 is realized by, for example, a network interface card (NIC) or the like. The communication unit 11 is wirelessly connected to the server device 100 via the network N to transmit and receive various types of information to and from the server device 100.

The near-field wireless communication unit 12 is realized by, for example, an NIC or the like. The near-field wireless communication unit 12 is connected to the return port 30 and the user terminal 50 by a near-field wireless communication method to transmit and receive various types of information to and from the return port 30 and the user terminal 50. As the near-field wireless communication method, near field communication (NFC), ultra wide band (UWB), or the like can be used in addition to the above-described Bluetooth.

The storage unit 13 is realized by, for example, a semiconductor memory element such as a random access memory (RAM), a read only memory (ROM), or a flash memory, or a storage device such as a hard disk or an optical disk.

In the example illustrated in FIG. 3, the storage unit 13 stores detection-related information 13a. The detection-related information 13a is information including various detection parameters and the like used for processing of detection by a detection unit 14b to be described later.

The control unit 14 is a controller, and is realized by, for example, a central processing unit (CPU), a micro processing unit (MPU), or the like executing various programs (not illustrated) stored in the storage unit 13 using the RAM as a work area. Furthermore, the control unit 14 can be realized by, for example, an integrated circuit such as an application specific integrated circuit (ASIC) or a field programmable gate array (FPGA).

The control unit 14 includes an acquisition unit 14a, a detection unit 14b, a lock control unit 14c, and a notification unit 14d, and executes or realizes functions or effects of information processing to be described below.

The acquisition unit 14a acquires data sensed by the in-vehicle sensor unit 2, for example, a GPS sensor value. The detection unit 14b traces a position relative to the user terminal 50 via the near-field wireless communication unit 12, and detects a distance from the user terminal 50. In addition, the detection unit 14b detects a theft of the bicycle B by determining whether the bicycle B is moving together with the user U based on the sensed data acquired by the acquisition unit 14a and the relative position information described above.

The lock control unit 14c controls the lock mechanism 3 to lock or unlock the bicycle B based on relative positions of the in-vehicle device 10 and the user terminal 50 or an operation of the user U. The notification unit 14d performs various notifications, for example, to the user terminal 50 according to a state transition in the moving object management system 1 to be described later.

### <2-3. Configuration of Return Port>

Next, as illustrated in FIG. 4, the return port 30 includes a radio wave transmission unit 31. The radio wave transmission unit 31 transmits a radio wave within a predetermined peripheral range.

The transmitted radio wave is received by the in-vehicle device 10 of the bicycle B stopped at the return port 30. When receiving the radio wave, the in-vehicle device 10 detects that the bicycle B is returned and stopped at the return port 30.

### <2-4. Configuration of User Terminal>

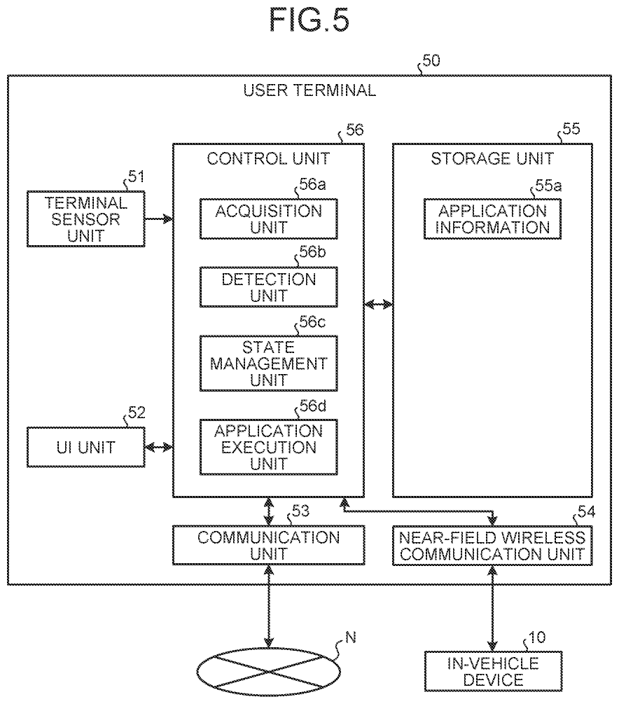

Next, as illustrated in FIG. 5, the user terminal 50 includes a terminal sensor unit 51, a UI unit 52, a communication unit 53, a near-field wireless communication unit 54, a storage unit 55, and a control unit 56.

The terminal sensor unit 51 is a group of various sensors mounted on the user terminal 50. The terminal sensor unit 51 includes, for example, a GPS sensor, an acceleration sensor, a gyro sensor, and the like.

The UI unit 52 is a component that provides a user interface to the user U, and includes an operation unit, a display unit, and a voice output unit. The UI unit is realized by, for example, a touch panel display, a speaker, and the like.

Similarly to the communication unit 11 described above, the communication unit 53 is realized by, for example, an NIC or the like. The communication unit 53 is wirelessly connected to the server device 100 via the network N to transmit and receive various types of information to and from the server device 100.

Similarly to the near-field wireless communication unit 12 described above, the near-field wireless communication unit 54 is realized by, for example, an NIC or the like. The near-field wireless communication unit 54 is connected to the in-vehicle device 10 by a near-field wireless communication method to transmit and receive various types of information to and from the in-vehicle device 10. As the near-field wireless communication method, Bluetooth, NFC, UWB, or the like described above can be used.

Similarly to the storage unit 13 described above, the storage unit 55 is realized by, for example, a semiconductor memory element such as a RAM, a ROM, or a flash memory, or a storage device such as a hard disk or an optical disk.

In the example illustrated in FIG. 5, the storage unit 55 stores application information 55a. The application information 55a includes a dedicated application program for the service for temporarily using the bicycle B to be executed by the control unit 56 or the like.

Similarly to the control unit 14 described above, the control unit 56 is a controller, and is realized by, for example, a CPU, an MPU, or the like executing various programs stored in the application information 55a or the like of the storage unit 55 using the RAM as a work area. Furthermore, the control unit 56 can be realized by, for example, an integrated circuit such as an ASIC or an FPGA.

The control unit 56 includes an acquisition unit 56a, a detection unit 56b, a state management unit 56c, and an application execution unit 56d, and executes or realizes functions or effects of information processing to be described below.

The acquisition unit 56a acquires data sensed by the terminal sensor unit 51, for example, a GPS sensor value. The detection unit 56b traces a position relative to the in-vehicle device 10 via the near-field wireless communication unit 12, and detects a distance from the in-vehicle device 10.

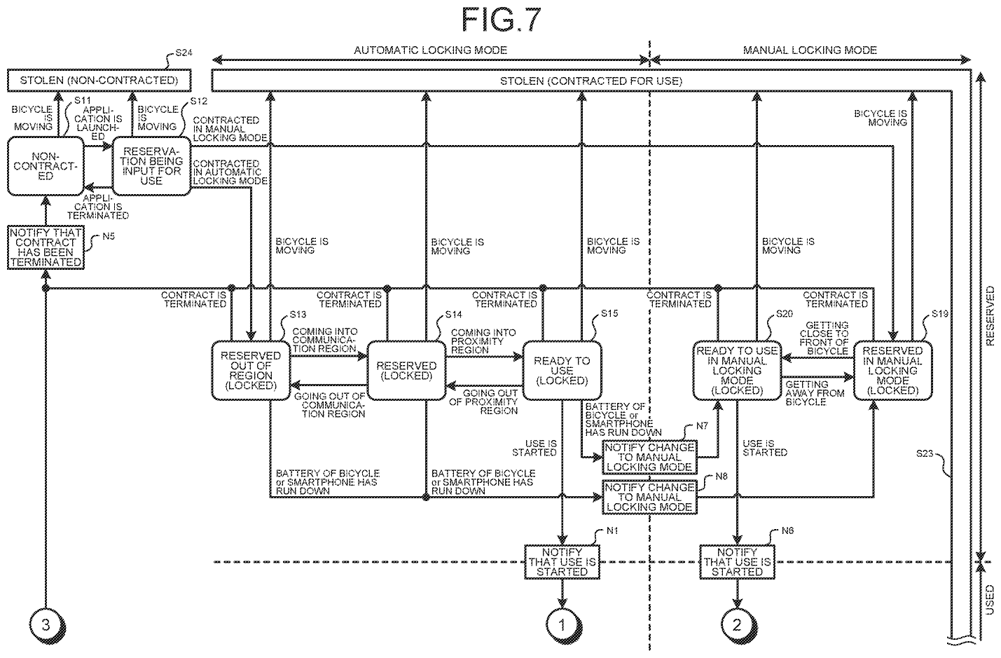

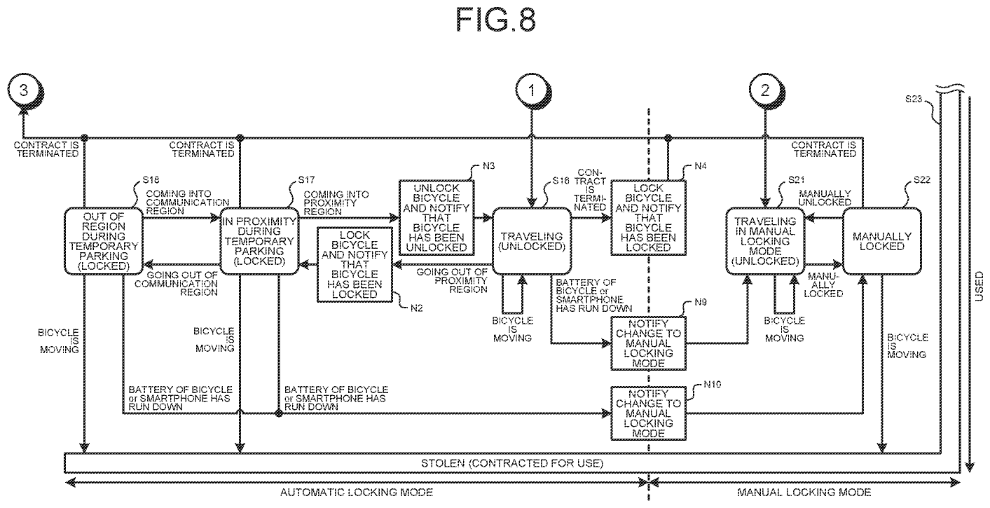

The state management unit 56c manages a state transition in the moving object management system 1. Such a state transition will be described later with reference to FIGS. 7 and 8. The application execution unit 56d executes the dedicated application described above based on the application information 55a.

### <2-5. Configuration of Server Device>

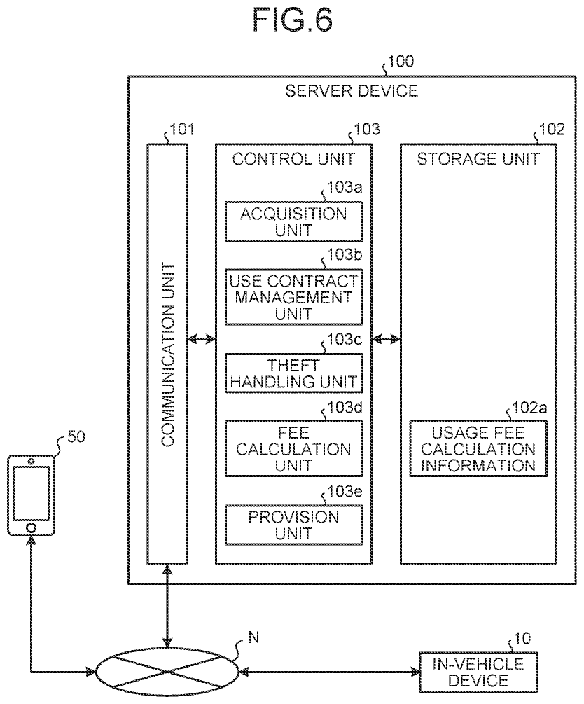

Next, as illustrated in FIG. 6, the server device 100 includes a communication unit 101, a storage unit 102, and a control unit 103.

Similarly to the communication unit 11 and the communication unit 53 described above, the communication unit 101 is realized by, for example, an NIC or the like. The communication unit 101 is wirelessly connected to the in-vehicle device 10 and the user terminal 50 via the network N to transmit and receive various types of information to and from the in-vehicle device 10 and the user terminal 50.

Similarly to the storage unit 13 and the storage unit 55 described above, the storage unit 102 is realized by, for example, a semiconductor memory element such as a RAM, a ROM, or a flash memory, or a storage device such as a hard disk or an optical disk.

In the example illustrated in FIG. 5, the storage unit 102 stores usage fee calculation information 102a. The usage fee calculation information 102a includes various parameters related to fee calculation, such as a fee table used when a fee is calculated by a fee calculation unit 103d to be described later.

Similarly to the control unit 14 and the control unit 56 described above, the control unit 103 is a controller, and is realized by, for example, a CPU, an MPU, or the like executing various programs (not illustrated) stored in the storage unit 102 using the RAM as a work area. Furthermore, the control unit 103 can be realized by, for example, an integrated circuit such as an ASIC or an FPGA.

The control unit 103 includes an acquisition unit 103a, a use contract management unit 103b, a theft handling unit 103c, a fee calculation unit 103d, and a provision unit 103e, and executes or realizes functions or effects of information processing to be described below.

The acquisition unit 103a acquires various types of information from the in-vehicle device 10 and the user terminal 50 via the communication unit 101. The use contract management unit 103b manages a use contract made with the user U, that is, various types of information such as whether to use the automatic locking mode and a use period.

When a theft of the bicycle B is detected by the in-vehicle device 10, the theft handling unit 103c receives the detection of the theft, and notifies the user terminal 50 of the detection of the theft. The fee calculation unit 103d calculates a usage fee depending on a state transition and the like to be described later.

The provision unit 103e provides, to the user terminal 50 via the communication unit 101, various types of information generated in the server device 100, for example, a fee calculation result, a usage status of the bicycle B up to a current time, and the like.

### 3. Description of State Transition

Next, a state transition in the moving object management system 1 will be described with reference to FIGS. 7 and 8. FIGS. 7 and 8 are diagrams (state transition 1) and (state transition 2) each illustrating a state transition in the moving object management system 1 according to the embodiment of the present disclosure. Note that, hereinafter, the bicycle B may be appropriately rephrased as the “in-vehicle device 10”. Similarly, the user U may be appropriately rephrased as the “user terminal 50”.

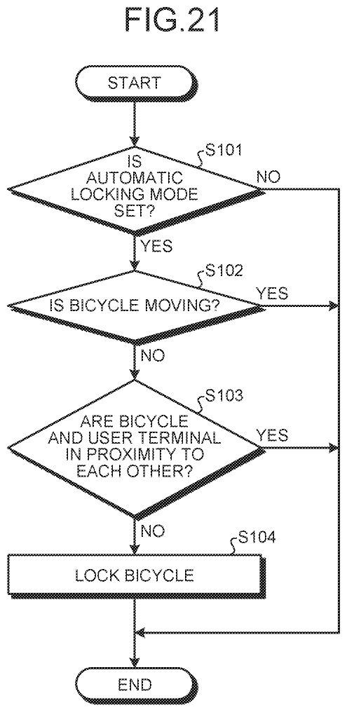

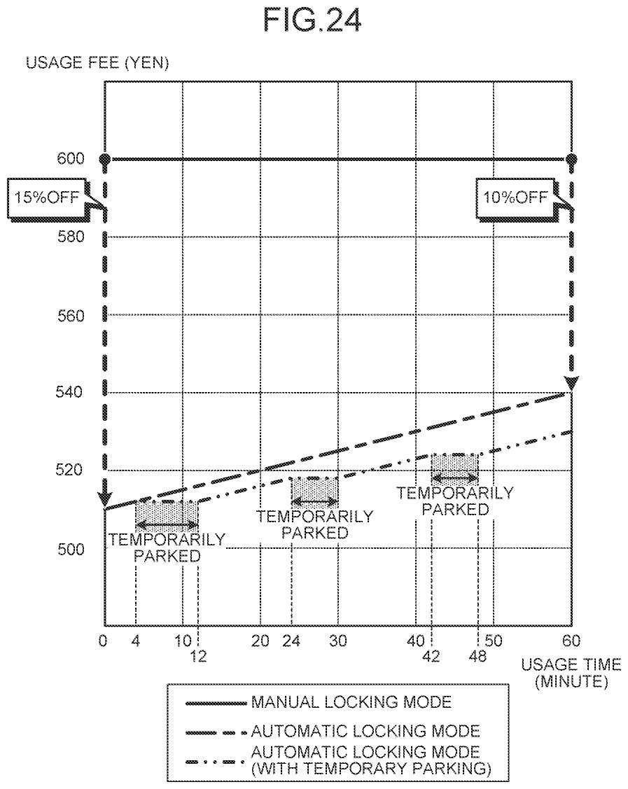

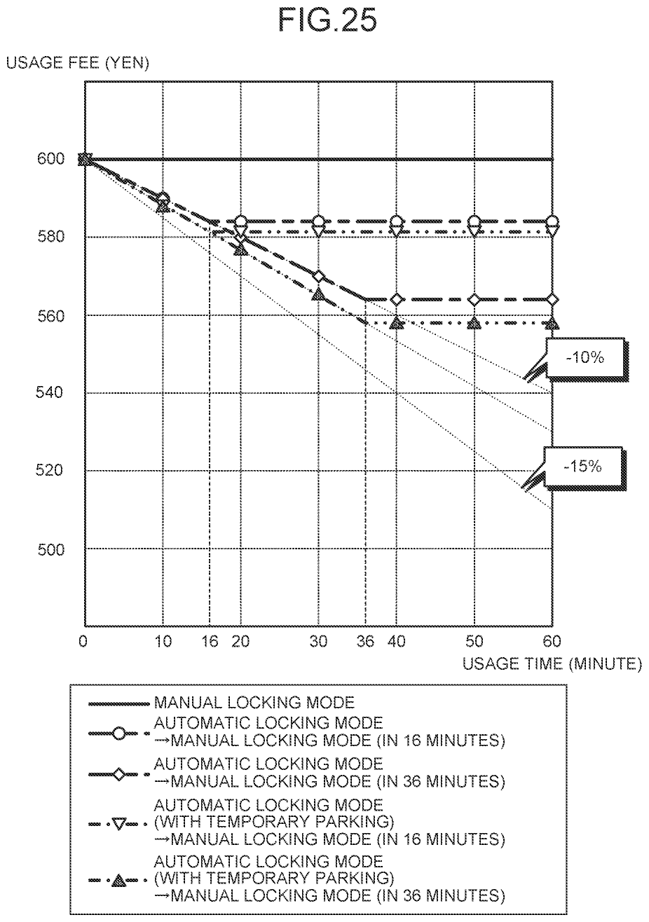

Furthermore, FIG. 9 to FIG. 25 will be appropriately referred to in the following description. FIGS. 9 to 20 are diagrams (UI screen 1) to (UI screen 12) each illustrating a specific example of a UI screen presented on the user terminal 50. FIGS. 21 to 23 are flowcharts (flowchart 1) to (flowchart 3) each illustrating a processing procedure executed by the moving object management system 1. FIGS. 24 and 25 are diagrams (usage fee 1) and (usage fee 2) for explaining the usage fee.

### <3-1. Start of Reservation>

As illustrated in FIG. 7, the user U in a “non-contracted” state (S11) first starts a dedicated application for the service for temporarily using the bicycle B on his/her user terminal 50, connects the user terminal 50 to the server device 100 through the communication unit 53 to make a use contract. Then, the bicycle B becomes in a “reservation being input for use” state (S12). At this time, an intention is expressed as to whether to use the relative position information between the bicycle B and the user U via a UI screen illustrated in FIG. 9.

When the relative position information is used, the automatic locking mode is set, and the bicycle B becomes in a “reserved out of region (locked)” (S13) state. In the automatic locking mode, the bicycle B is automatically locked, and it does not occur to forget to lock the bicycle B, which reduces a risk of theft, thereby reducing a usage fee including an insurance fee.

On the other hand, when the relative position information is not used, the manual locking mode is set, and the bicycle B becomes in a “reserved in manual locking mode (locked)” state (S19). In the manual locking mode, the bicycle B is locked manually, which is equivalent to a normal temporary use service including operability and the like.

### <3-2. Detection of Bicycle>

When the detection unit 56b detects that the user U has come close to the place where the bicycle B is placed from information on a GPS position of the user terminal 50 or the like (if necessary, it is notified via the communication unit 53, the communication unit 101, and the communication unit 11 sequentially that the user U is close to the reserved bicycle B), the near-field wireless communication unit 54 secures a communication path for directly connecting the in-vehicle device 10 and the user terminal 50 to each other.

Note that, in order to attempt connection, the detection unit 56b of the user terminal 50 activates a radio wave transmission/reception unit of the near-field wireless communication unit 54, and similarly, the detection unit 14b of the in-vehicle device 10 also activates a radio wave transmission/reception unit of the near-field wireless communication unit 12.

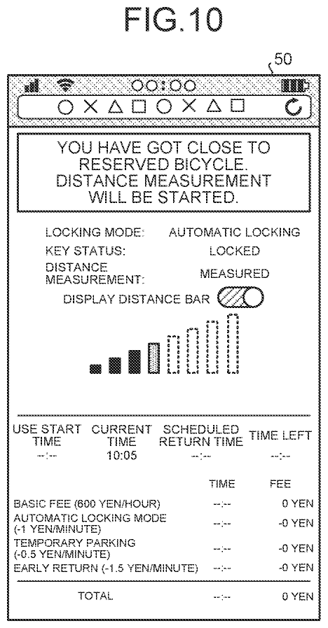

While observing an intensity of a radio wave and an error rate, it is started to trace relative positions of the in-vehicle device 10 and the user terminal 50, and the relative position information is shared between the in-vehicle device 10 and the user terminal 50 via the server device 100 or by using the direct communication path established this time. At this time, the bicycle B becomes in a “reserved (locked)” state (S14), and a UI screen illustrated in FIG. 10 is presented on the user terminal 50.

Note that the position detection method is not limited to the method using a radio wave. For example, one of the in-vehicle device 10 and the user terminal 50 outputs a voice through a speaker, and the other one collects the voice through a microphone and determines relative positions from the volume of the voice. At this time, by using the UI unit 52 to provide feedback to the user U as to whether the distance to the bicycle B is getting closer or farther, it is also possible to navigate until reaching the bicycle B.

### <3-3. Start of Use (Travel)>

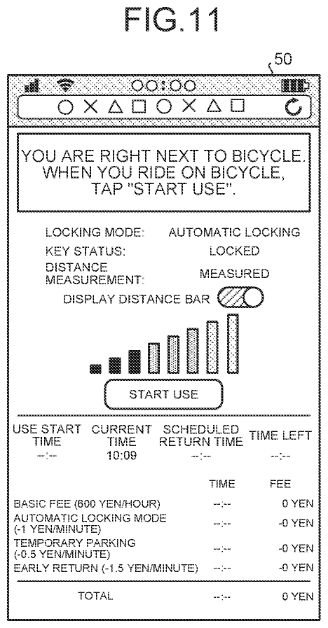

As illustrated in a UI screen of FIG. 11, when the detection unit 56b recognizes that the user terminal 50 and the bicycle B have come close to each other, the bicycle B becomes in a “ready to use (locked)” state (S15). Then, when the user U expresses an intention to start use through the UI unit 52 in a state where the user rides on the bicycle B, the lock control unit 14c determines to unlock the bicycle B and controls the lock mechanism 3 to unlock the bicycle B.

The user terminal 50 that has received such unlocking information notifies via the UI unit 52 that use is started (N1), and performs relative position calibration for determination in the proximity region R1. Then, the state transitions to a “traveling (unlocked)” state illustrated in FIG. 8 (S16). Note that the relative position calibration may be periodically updated during traveling.

### <3-4. Temporary Parking>

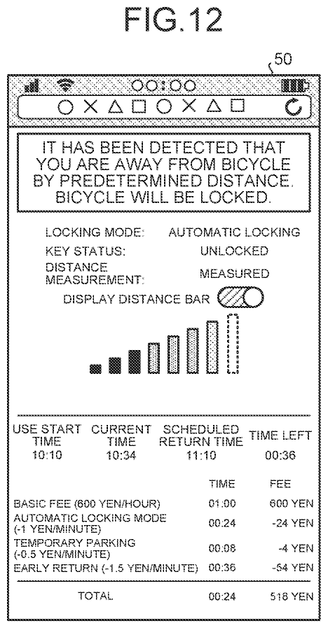

When the detection unit 14b determines that the relative position is out of the proximity region R1 during the “traveling (unlocked)” state, the lock control unit 14c automatically locks the bicycle B. The user terminal 50 that has received such locking information determines that the user U is away from the bicycle B and the bicycle B is in a temporarily parked state, the state management unit 56c shifts the state to an “in proximity during temporary parking (locked)” state (S17). Then, it is notified that the bicycle B has been locked (N2) to the user U through a UI screen or the like as illustrated in FIG. 12.

In addition, the lock control unit 14c executes fail-safe processing so as not to be suddenly locked during traveling when a correct relative position cannot be obtained due to a failure of the detection unit 14b, radio wave interference, or the like.

Specifically, as illustrated in FIG. 21, the lock control unit 14c determines whether the automatic locking mode is set (Step S101). Here, when the automatic locking mode is set (Step S101, Yes), the lock control unit 14c subsequently determines whether the bicycle B is moving (Step S102).

Then, when the bicycle B is not moving (Step S102, No), the lock control unit 14c subsequently determines whether the bicycle B and the user terminal 50 are in proximity to each other (Step S103).

Then, when the bicycle B and the user terminal 50 are not in proximity to each other (Step S103, No), the lock control unit 14c locks the bicycle B (Step S104), and ends the processing. On the other hand, when the automatic locking mode is not set (Step S101, No), when the bicycle B is moving (Step S102, Yes), or when the bicycle B and the user terminal 50 are in proximity to each other (Step S103, Yes), the processing ends.

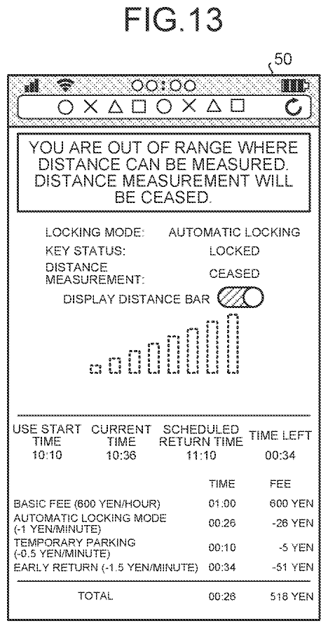

The description of FIG. 8 will be returned. In the “in proximity during temporary parking (locked)” state (S17), when the user U is out of a region in which the relative positions can be traced, that is, out of a communication region, the tracing of the relative positions is temporarily stopped in order to suppress the battery consumption of the bicycle B and the user terminal 50, and an “out of region during temporary parking” state is set (S18). At this time, a UI screen as illustrated in FIG. 13 is presented on the user terminal 50.

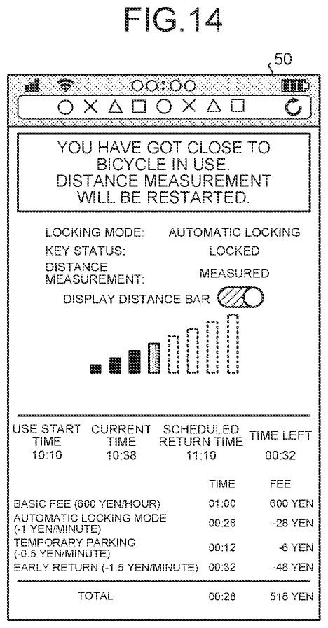

Note that, starting from the “out of region during temporary parking” state (S18), it may be considered, as a method of restarting tracing relative positions, to present a UI screen as illustrated in FIG. 14 from the time point when it is grasped that the user U has returned nearby based on the GPS position information or the like.

### <3-5. Restart of Use>

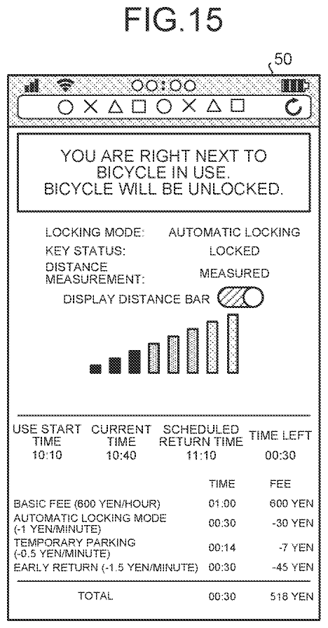

When the detection unit 56b detects that the user U has got close to the bicycle B within the proximity region R1 during the “in proximity during temporary parking (locked)” state (S17), the state management unit 56c instructs the lock control unit 14c to unlock the bicycle B, presents a UI screen as illustrated in FIG. 15 to notify the user U that the bicycle B has been unlocked (N3), and shifts the state to the “traveling (unlocked)” state (S16).

### <3-6. Termination of Use>

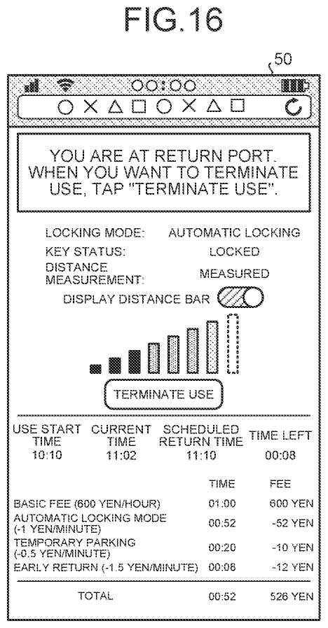

When receiving a radio wave of the return port 30 while the bicycle B is locked, the in-vehicle device 10 detects that the vehicle is stopped at the return port 30 and notifies the user terminal 50 of the fact. When it is grasped that the bicycle B is stopped at the return port 30 while being locked (S13 to S15, S17 to S20, and S22), the state management unit 56c presents a UI screen as illustrated in FIG. 16 to have a confirmation from the user U as to whether to terminate the use contract.

Then, when the user U expresses an intention to terminate the use via the UI unit 52, it is notified that the contract has been terminated (N5), and the use contract can be ended. When the use contract is terminated, the state transitions to the “non-contracted” state (S11).

The fee calculation unit 103d periodically calculates a usage fee at the latest time point to be displayed on the UI unit 52 of the user terminal 50 during the contracted state, but settles a final usage fee and notifies the UI unit of the final usage fee after the contract is terminated.

### <3-7. Report of Theft>

The detection unit 14b determines whether the bicycle B is moving together with the user U or not moving together with the user U by using a change in position of the bicycle B from the in-vehicle sensor unit 2 and the relative position information. Then, when the user U is not moving together with the user U, the theft handling unit 103c reports a theft to the temporary use service provider.

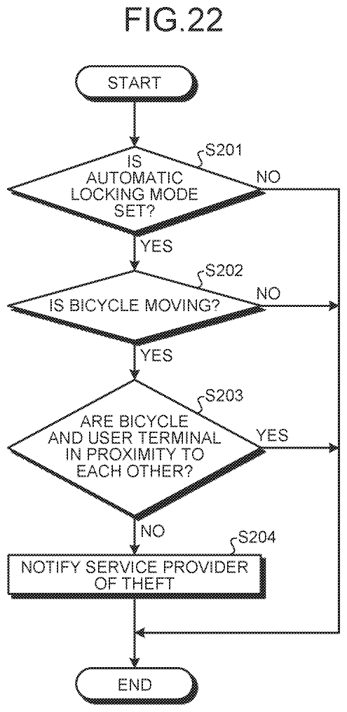

In such theft-related processing, specifically, as illustrated in FIG. 22, the detection unit 14b determines whether the automatic locking mode is set (Step S201). Here, when the automatic locking mode is set (Step S201, Yes), the detection unit 14b subsequently determines whether the bicycle B is moving (Step S202).

Then, when the bicycle B is moving (Step S202, Yes), the detection unit 14b subsequently determines whether the bicycle B and the user terminal 50 are in proximity to each other (Step S203).

Then, when the bicycle B and the user terminal 50 are not in proximity to each other (Step S203, No), the theft handling unit 103c reports a theft to the temporary use service provider (Step S204), and the processing ends. On the other hand, when the automatic locking mode is not set (Step S201, No), when the bicycle B is not moving (Step S202, No), or when the bicycle B and the user terminal 50 are in proximity to each other (Step S203, Yes), the processing ends.

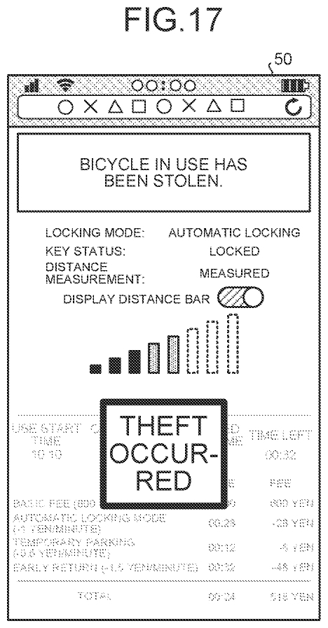

Note that, when the user U is close to the bicycle B, or the like, the theft handling unit 103c also notifies the user U through a UI screen as illustrated in FIG. 17 or the like. As a result, there is a possibility that an offender may be caught red-handed. Note that a certain kind of incentive may be given to the user U when the user U who has received a report of theft can provide information regarding the theft to the temporary use service provider or can catch the offender red-handed. Examples of the incentive include offering a coupon for next use as a gift, adding points in a point program provided by the service provider, and the like.

### <3-8. Switch to Manual Locking Mode>

The description of FIG. 8 will be returned. It may not be possible to trace relative positions as the battery of the bicycle B or the user terminal 50 runs down under contract. When it is not possible to trace a relative position of the bicycle B, the detection unit 14b transmits information indicating the fact to the state management unit 56c immediately before a relative position of the bicycle B cannot be traced, and when it is not possible to trace a relative position of the user terminal 50, the detection unit 56b transmits information indicating the fact to the state management unit 56c immediately before a relative position of the user terminal 50 cannot be traced.

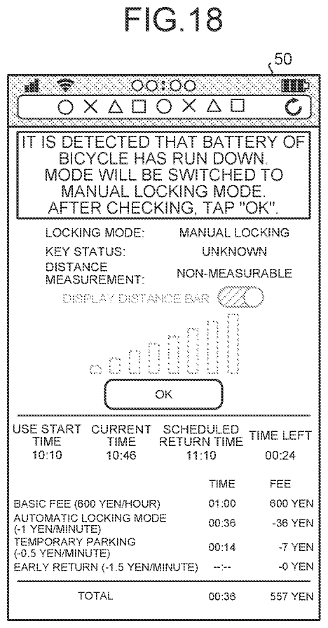

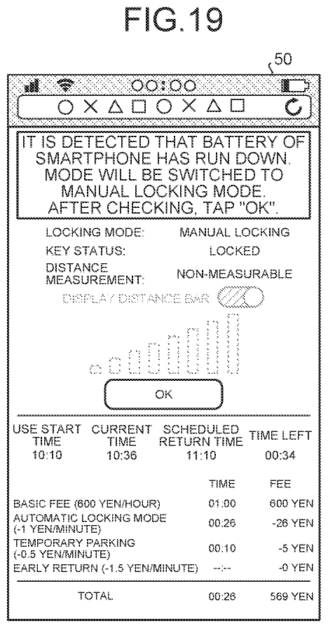

In such a case, the state management unit 56c notifies the user U of a manual mode change notification indicating that the automatic locking mode is switched to the manual locking mode through a UI screen or the like as illustrated in FIG. 18 or 19 (N7 to N10). Then, the temporary use service is continuously used in the manual locking mode (S19 to S22).

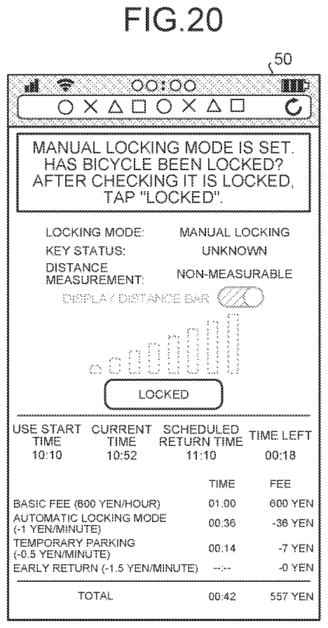

Furthermore, in the manual locking mode, when it is detected that the user U is walking on the basis of the acceleration sensor or the like of the terminal sensor unit 51, the user U is alerted to lock the bicycle B through a UI screen or the like as illustrated in FIG. 20. In response to the alert, after checking whether the bicycle B has been locked, the user U self-reports the check result, for example, by tapping “locked” illustrated in FIG. 20. In the manual locking mode, it is not possible to confirm that the user U has moved away from the bicycle B. Therefore, when it is detected that the user U is walking, the user U may be alerted periodically and repeatedly to an extent in which the user U does not feel troublesome.

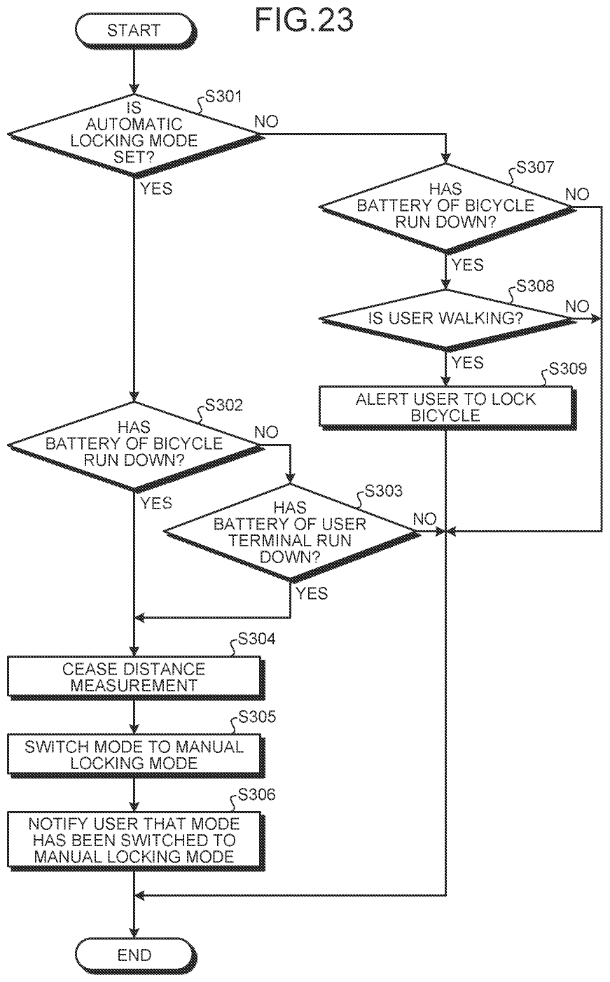

Specifically, as illustrated in FIG. 23, in the processing procedure related to the switch to the manual locking mode, it is first determined whether the automatic locking mode is set (Step S301). Then, when the automatic locking mode is set (Step S301, Yes), it is subsequently determined whether the battery of the bicycle B has run down (Step S302).

When the battery of the bicycle B has not run down (Step S302, No), it is subsequently determined whether the battery of the user terminal 50 has run down (Step S303). When the battery of the user terminal 50 has not run down (Step S303, No), the processing ends.

When the battery of the bicycle B has run down (Step S302, Yes) or when the battery of the user terminal 50 has run down (Step S303, Yes), the distance measurement is ceased (Step S304), and the bicycle B is switched to the manual locking mode (Step S305).

Then, the user U is notified that the bicycle B has been switched to the manual locking mode (Step S306), and the processing ends.

When the automatic locking mode is not set (Step S301, No), it is subsequently determined whether the battery of the bicycle B has run down (Step S307). Then, when the battery of the bicycle B has run down (Step S307, Yes), it is determined whether the user U is walking (Step S308).

Here, when the user U is walking (Step S308, Yes), the user U is alerted to lock the bicycle B (Step S309). Then, the processing ends.

On the other hand, when the battery of the bicycle B has not run down (Step S307, No) or when the user U is not walking (Step S308, No), the processing ends.

### <3-9. Usage Fee>

In the automatic locking mode, the bicycle B is automatically locked when the bicycle is not traveling, which reduces a risk of theft. Therefore, the insurance fee included in the usage fee can be lowered with respect to the normal usage fee in the manual locking mode. In addition, while the bicycle B is temporarily parked and automatically locked, the bicycle B can be considered to be managed by the temporary use service provider, and it can be said that the user U has no responsibility for management during that time.

Then, the insurance fee borne by the user U can be reduced as compared with that during traveling. Based on the above, description will be made with reference to FIGS. 24 and 25. FIG. 24 illustrates a difference in usage fee between the automatic locking mode and the manual locking mode. In addition, FIG. 25 illustrates a difference in usage fee when a switch to the manual locking mode has occurred.

As illustrated in FIGS. 24 and 25, in the present embodiment, the fees are set in such a manner that the basic fee applied when the manual locking mode is used all the time is set to 600 yen/hour, the discount applied when the automatic locking mode is used is set to −1 yen/minute (10% off), the discount for the time during which the bicycle B is temporarily parked in the automatic locking mode or the remaining use time when the bicycle B is returned early to the return port 30 is further set to −0.5 yen/minute (a total of 15% off in combination with the discount for the automatic locking mode), and there is no discount after the bicycle B is switched to the manual locking mode for the reason that relative distances cannot be measured as the battery has run down or the like.

In the example of FIG. 24, first, in the manual locking mode, it can be seen that the usage fee is 600 yen in a fixed manner within 60 minutes even if the bicycle B is returned early.

In addition, it can be seen that, in the automatic locking mode, the usage fee is calculated as 10% off while the bicycle B is traveling, and when the bicycle B is returned early, the usage fee is calculated as 15% off for the remaining time. For example, if the use is terminated immediately after the start of the use, the usage fee is 510 yen, which is 15% off, and if the bicycle B is returned after continuous travel for 60 minutes, the usage fee is 540 yen, which is 10% off.

In addition, it can be seen that, when the bicycle B has ever been temporarily parked in the automatic locking mode, for example, when the bicycle B is temporarily parked during a period in 4 minutes to 12 minutes, a period in 24 minutes to 30 minutes, and a period in 42 minutes to 48 minutes, the usage fee does not increase or decrease in such periods during which the bicycle B is temporarily parked.

In the example of FIG. 25, it can be seen that, when the automatic locking mode is switched to the manual locking mode in 16 minutes or 36 minutes without temporary parking, the usage fee does not change even if the bicycle B is returned early after the mode is switched.

In addition, it can be seen that, even when the automatic locking mode with temporary parking similar to what is illustrated in FIG. 24 is switched to the manual locking mode in 16 minutes or 36 minutes, the usage fee does not change even if the bicycle B is returned early after the mode is switched.

As described above, the moving object management method according to the embodiment is capable of dynamically reflecting a difference in insurance fee to be borne according to the risk of theft and the responsibility for management in the usage fee depending on whether the automatic locking mode is set and whether the bicycle B is temporarily parked.

### <3-10. Others>

In addition, the moving object management method according to the embodiment is capable of accurately grasping a time during which the automatic locking mode, which has a low risk of theft, is used, so that the usage fee can be reduced during the automatic locking mode. In addition, the moving object management method according to the embodiment is capable of automatically lock the bicycle B in a fine manner by accurately detecting a distance between the in-vehicle device 10 and the user terminal 50, so that it is possible to more accurately grasp whether the bicycle B is traveling or temporarily parked. In addition, the moving object management method according to the embodiment is capable of discounting the usage fee according to the actual traveling time or the actual temporary stop time, and using the usage fee as more accurate behavior data.

In addition, the moving object management method according to the embodiment is capable of finely grasping that the user U is getting close to or away from the bicycle B, so that it is also possible to control the preparation for traveling according to the situation, such as starting to make the seat warm in winter when the user U approaches the bicycle B to some extent.

### 4. Other Modifications

Note that the above-described embodiments can further include some modifications.

Among the processes described in the above-described embodiments, all or some of the processes described as being automatically performed can be manually performed, or all or some of the processes described as being manually performed can be automatically performed by known methods. In addition, the processing procedures, the specific terms, and the information including various kinds of data and parameters described hereinabove and illustrated in drawings can be arbitrarily changed unless otherwise specified. For example, the various kinds of information illustrated in each of the drawings are not limited to the illustrated information.

In addition, each component of each device illustrated in the drawings is functionally conceptual, and is not necessarily configured as illustrated in the drawings in physical term. That is, a specific form in which the devices are distributed or integrated is not limited to what is illustrated, and all or some of the devices can be configured to be functionally or physically distributed or integrated in an arbitrary unit according to various loads, usage conditions, and the like.

In addition, the above-described embodiments can be appropriately combined unless any processing contradiction is caused. In addition, the order of the steps illustrated in the sequence diagram or the flowchart according to the present embodiment can be changed as appropriate.

### 5. Hardware Configuration

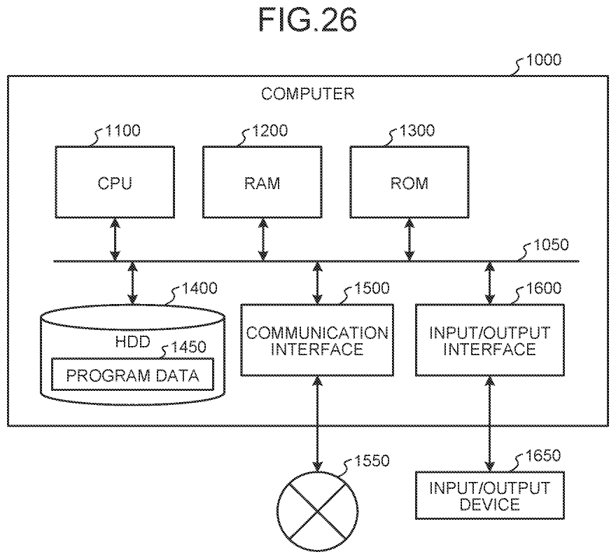

Each of the in-vehicle device 10, the user terminal 50, and the server device 100 according to the above-described embodiment are realized by, for example, a computer 1000 having a configuration as illustrated in FIG. 26. The in-vehicle device 10 will be described as an example. FIG. 26 is a hardware configuration diagram illustrating an example of the computer 1000 realizing the functions of the in-vehicle device 10. The computer 1000 includes a CPU 1100, a RAM 1200, a ROM 1300, a storage 1400, a communication interface 1500, and an input/output interface 1600. The units of the computer 1000 are connected to each other by a bus 1050.

The CPU 1100 operates on the basis of programs stored in the ROM 1300 or the storage 1400 to control each unit. For example, the CPU 1100 develops in the RAM 1200 the programs stored in the ROM 1300 or the storage 1400, and executes processing corresponding to various kinds of programs.

The ROM 1300 stores a boot program such as a basic input output system (BIOS) executed by the CPU 1100 when the computer 1000 starts up, a program depending on the hardware of the computer 1000, and the like.

The storage 1400 is a computer-readable recording medium that non-transiently records a program executed by the CPU 1100, data used by the program, and the like. Specifically, the storage 1400 is a recording medium that records an information processing program according to the present disclosure, which is an example of program data 1450.

The communication interface 1500 is an interface for the computer 1000 to be connected to an external network 1550. For example, the CPU 1100 receives data from another device or transmits data generated by the CPU 1100 to another device via the communication interface 1500.

The input/output interface 1600 is an interface for connecting an input/output device 1650 and the computer 1000 to each other. For example, the CPU 1100 can receive data from an input device such as a keyboard or a mouse via the input/output interface 1600. In addition, the CPU 1100 can transmit data to an output device such as a display, a speaker, or a printer via the input/output interface 1600. Furthermore, the input/output interface 1600 may function as a media interface that reads a program or the like recorded in a predetermined recording medium. The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the in-vehicle device 10 according to the embodiment of the present disclosure, the CPU 1100 of the computer 1000 realizes the function of the control unit 14 by executing the information processing program loaded on the RAM 1200. In addition, the information processing program and the data in the storage unit 13 according to the present disclosure are stored in the storage 1400. Note that the CPU 1100 reads the program data 1450 to be executed from the storage 1400, but as another example, these programs may be acquired from other devices via the external network 1550.

### 6. Conclusion

As described above, according to an embodiment of the present disclosure, a moving object management system 1 includes: a detection unit 14b that traces relative positions of a bicycle B (corresponding to an example of a “moving object”) and a user terminal 50 carried by a user U who temporarily uses the bicycle B, and that detects a distance based on the traced relative positions; a lock control unit 14c that performs automatic locking with respect to the bicycle B depending on the distance detected by the detection unit 14b; and a fee calculation unit 103d that dynamically changes a usage fee for using the bicycle B according to a state in which the automatic locking is used. As a result, it is possible to accurately grasp a status of the bicycle B and appropriately reflect a difference in risk in the usage fee while the bicycle B is temporarily used.

Although the embodiments of the present disclosure have been described above, the technical scope of the present disclosure is not limited to each of the above-described embodiments as it is, and various modifications can be made without departing from the gist of the present disclosure. In addition, components in the different embodiments and modifications may be appropriately combined.

Furthermore, the effects of each of the embodiments described in the present specification are merely exemplary and are not restrictive, and each of the embodiments described in the present specification may have other effects.

Note that the present technology can also take the following configurations.
(1)
   A moving object management system comprising:
   a detection unit that traces relative positions of a moving object and a user terminal carried by a user who temporarily uses the moving object, and that detects a distance based on the traced relative positions;
   a lock control unit that performs automatic locking with respect to the moving object depending on the distance detected by the detection unit; and
   a fee calculation unit that dynamically changes a usage fee for using the moving object according to a state in which the automatic locking is used.
(2)
   The moving object management system according to (1), wherein
   the lock control unit
   performs the automatic locking when the user expresses an intention to use the automatic locking via the user terminal.
(3)
   The moving object management system according to (1) or (2), wherein
   the detection unit
   traces the relative positions when the user terminal is within a predetermined trace region in which the moving object is included.
(4)
   The moving object management system according to (3), wherein
   the lock control unit
   performs automatic unlocking when the detection unit detects that the user terminal is within a predetermined proximity region included in the trace region.
(5)
   The moving object management system according to (4), wherein
   after the automatic unlocking is performed by the lock control unit,
   the user terminal performs relative position calibration within the proximity region in a state where the user rides on the moving object.
(6)
   The moving object management system according to (4) or (5), wherein
   the lock control unit
   performs the automatic locking when the detection unit detects that the user terminal is out of the proximity region.
(7)
   The moving object management system according to (6), wherein
   when the automatic locking is performed by the lock control unit, the user terminal regards the moving object as being in a temporarily parked state.
(8)
   The moving object management system according to (7), wherein
   when the detection unit detects that the moving object or the user terminal has degraded in function, the automatic locking is disabled, and the lock control unit switches the locking of the moving object to manual locking.
(9)
   The moving object management system according to (7) or (8), wherein
   the fee calculation unit
   calculates the usage fee so that the usage fee is lower when the automatic locking is used than when the automatic locking is not used.
(10)
   The moving object management system according to (7), (8) or (9), wherein
   the fee calculation unit
   calculates the usage fee so as not to increase or decrease while the moving object is in the temporarily parked state.
(11)
   The moving object management system according to any one of (3) to (10), wherein
   the detection unit
   traces the relative positions while using near-field wireless communication.
(12)
   The moving object management system according to (11), wherein
   the detection unit
   traces the relative positions using the near-field wireless communication when the user terminal is within a predetermined communication region of the moving object, which is the trace region.
(13)
   The moving object management system according to any one of (1) to (12), wherein
   in a case where the automatic locking is usable, when the moving object is moving but the relative positions of the moving object and the user terminal are not close to each other, the detection unit detects a theft of the moving object.
(14)
   A moving object management method executed by one or more computers included in a moving object management system, the moving object management method comprising:
   tracing relative positions of a moving object and a user terminal carried by a user who temporarily uses the moving object, and detecting a distance based on the traced relative positions;
   performing automatic locking with respect to the moving object depending on the detected distance in the detecting; and
   dynamically changing a usage fee for using the moving object according to a state in which the automatic locking is used.

### REFERENCE SIGNS LIST

1 MOVING OBJECT MANAGEMENT SYSTEM
10 IN-VEHICLE DEVICE
11 COMMUNICATION UNIT
12 NEAR-FIELD WIRELESS COMMUNICATION UNIT
13 STORAGE UNIT
14 CONTROL UNIT
14a ACQUISITION UNIT
14b DETECTION UNIT
14c LOCK CONTROL UNIT
14d NOTIFICATION UNIT
50 USER TERMINAL
53 COMMUNICATION UNIT
54 NEAR-FIELD WIRELESS COMMUNICATION UNIT
55 STORAGE UNIT
56 CONTROL UNIT
56a ACQUISITION UNIT
56b DETECTION UNIT
56c STATE MANAGEMENT UNIT
56d APPLICATION EXECUTION UNIT
100 SERVER DEVICE
101 COMMUNICATION UNIT
102 STORAGE UNIT
103 CONTROL UNIT
103a ACQUISITION UNIT
103b USE CONTRACT MANAGEMENT UNIT
103c THEFT HANDLING UNIT
103d FEE CALCULATION UNIT
103e PROVISION UNIT
B BICYCLE
R1 PROXIMITY REGION
U USER

1. A moving object management system comprising:
a detection unit that traces relative positions of a moving object and a user terminal carried by a user who temporarily uses the moving object, and that detects a distance based on the traced relative positions;
a lock control unit that performs automatic locking with respect to the moving object depending on the distance detected by the detection unit; and
a fee calculation unit that dynamically changes a usage fee for using the moving object according to a state in which the automatic locking is used.

2. The moving object management system according to claim 1, wherein
the lock control unit
performs the automatic locking when the user expresses an intention to use the automatic locking via the user terminal.

3. The moving object management system according to claim 1, wherein
the detection unit
traces the relative positions when the user terminal is within a predetermined trace region in which the moving object is included.

4. The moving object management system according to claim 3, wherein
the lock control unit
performs automatic unlocking when the detection unit detects that the user terminal is within a predetermined proximity region included in the trace region.

5. The moving object management system according to claim 4, wherein
after the automatic unlocking is performed by the lock control unit,
the user terminal performs relative position calibration within the proximity region in a state where the user rides on the moving object.

6. The moving object management system according to claim 4, wherein
the lock control unit
performs the automatic locking when the detection unit detects that the user terminal is out of the proximity region.

7. The moving object management system according to claim 6, wherein
when the automatic locking is performed by the lock control unit, the user terminal regards the moving object as being in a temporarily parked state.

8. The moving object management system according to claim 7, wherein
when the detection unit detects that the moving object or the user terminal has degraded in function, the automatic locking is disabled, and the lock control unit switches the locking of the moving object to manual locking.

9. The moving object management system according to claim 7, wherein
the fee calculation unit
calculates the usage fee so that the usage fee is lower when the automatic locking is used than when the automatic locking is not used.

10. The moving object management system according to claim 7, wherein
the fee calculation unit
calculates the usage fee so as not to increase or decrease while the moving object is in the temporarily parked state.

11. The moving object management system according to claim 3, wherein
the detection unit
traces the relative positions while using near-field wireless communication.

12. The moving object management system according to claim 11, wherein
the detection unit
traces the relative positions using the near-field wireless communication when the user terminal is within a predetermined communication region of the moving object, which is the trace region.

13. The moving object management system according to claim 1, wherein
in a case where the automatic locking is usable, when the moving object is moving but the relative positions of the moving object and the user terminal are not close to each other, the detection unit detects a theft of the moving object.

14. A moving object management method executed by one or more computers included in a moving object management system, the moving object management method comprising:
tracing relative positions of a moving object and a user terminal carried by a user who temporarily uses the moving object, and detecting a distance based on the traced relative positions;
performing automatic locking with respect to the moving object depending on the detected distance in the detecting; and
dynamically changing a usage fee for using the moving object according to a state in which the automatic locking is used.
